(19) United States
(12) Patent Application Publication
(10) Pub. No.: US 2002/0029238 A1
(43) Pub. Date: Mar. 7, 2002

(54) Scheduler, schedule adjusting method, distributed scheduler system and storage medium storing schedule adjusting program

(75) Inventor: Akio Okuhata, Kawasaki (JP)

Correspondence Address: ARMSTRONG,WESTERMAN & HATTORI, LLP, 1725 K STREET, NW., SUITE 1000, WASHINGTON, DC, 20006, US

(73) Assignee: Fujitsu Limited, Kawasaki (JP)

(21) Appl. No.: 09/984,829

(22) Filed: Oct. 31, 2001

Related U.S. Application Data
(63) Continuation of application No. PCT/JP99/04374, filed on Aug. 12, 1999.

(51) Int. Cl. G06F 9/00

(52) U.S. Cl. 709/101

(57) ABSTRACT

A plurality of schedulers is connected to each other through a network, thereby constructing a distributed schedule system. The scheduler processes a scheduler identifier for identifying a user and schedule information constituted by schedule data are stored by broadcasting with respect to another scheduler.

### TECHNICAL FIELD

The present invention relates to a scheduler, schedule adjusting method, a distributed scheduler system and a storing medium in which a schedule adjusting program is stored. More particularly, the invention relates to a distributed scheduler, a schedule adjusting method, a distributed scheduler system and a storing medium in which a schedule adjusting program is stored for adjusting a schedule by providing all schedulers with schedule information without using a server.

### BACK GROUND ART

Conventionally, in a distributed scheduler system, a server for managing schedule information is connected to a network, and a scheduler (client) for adjusting a schedule is disposed in each of a plurality of clients connected to the network. In such a distributed scheduler, all schedule information using the scheduler is saved in a scheduler database of the server, and the schedule information is unitarily managed on the server. Therefore, it is necessary to dispose a server when the distributed scheduler system is constructed, and there is a problem that a cost of the system is increased correspondingly. Further, when the number of users of the scheduler is increased or decreased, it is necessary to set the schedule information again, and labor and time for the maintenance of the server are necessary. When the schedule is actually adjusted, schedule information of a plurality of schedule-adjusting other party is referred to, it is judged whether there is a time coincidence, and if there is time coincidence, it is necessary to adjust the schedule while confirming checking with schedule-adjusting other party. However, in the conventional scheduler, the time coincidence in a plurality of schedules is judged from starting date and time and ending date and time of the schedules, and it is troublesome to judge the time coincidence.

### DISCLOSURE OF THE INVENTION

The present invention provides a scheduler, a schedule adjusting method, a distributed scheduler system and a storing medium in which a schedule adjusting program is stored and which can be read by a computer, in which a server is unnecessary, the scheduler can be introduced easily, fluctuations in the number of users can be accepted, time coincidence of schedules is flaccidly displayed so that the schedule can easily be adjusted.

Schedulers of the present invention for constructing a scheduler system by connecting the schedulers through a network, wherein each of the schedulers comprises a database in which a scheduler identifier for identifying a user and schedule information constituted by schedule data are stored, and a scheduler processing unit for processing the schedule information by broadcasting with respect to another scheduler. Therefore, it is unnecessary to dispose a server for unitarily managing the schedules, and the scheduler can easily be introduced initially. Further, since the schedules of users are not unitarily managed, the schedulers can easily meet the increase or decrease of scheduler users by subscription or withdrawal.

Therefore, the schedule data includes starting date and time, ending date and time and the like. The scheduler processing unit processes subscription to the scheduler group, communication of schedule information after subscription, and withdrawal from the scheduler group by broadcasting. The scheduler processing unit includes a scheduler connecting processing unit for taking part in the distributed scheduler system. The scheduler connecting processing unit sends a scheduler connecting request meaning subscription into a scheduler group together with own schedule information to all of the schedulers in the group connected to the network when the scheduler is connected to the network or at given intervals. The scheduler processing unit includes a schedule adding processing unit in correspondence with the scheduler connecting processing unit. The schedule adding processing unit monitors and receives schedule information having a scheduler connecting request sent on the network, and adds the received schedule information to the own database. The scheduler processing unit includes a schedule referring processing unit. The schedule referring processing unit sends a scheduler referring request meaning reference (obtaining) of schedule information of a particular scheduler which is a schedule-adjusting other party together with a scheduler identifier of the adjusting other party to all of the schedulers connected to the network, receives response information from another scheduler within a given time from the sending operation, and selects schedule information of the adjusting other party having the latest final renewal date to renew the database. The scheduler processing unit has a scheduler opening processing unit. The scheduler opening processing unit retrieves schedule information corresponding to a scheduler identifier of the schedule-adjusting other party from own database when the scheduler processing unit received scheduler referring request from another scheduler, wherein the scheduler opening processing unit sends the schedule information together with a schedule opening response meaning a response to the scheduler referring request to the network. The schedule information includes a final renewal date, the scheduler processing unit includes a scheduler deleting processing unit which deletes schedule information from the database if it has not been renewed for a given period of time based on the final renewal date of the schedule information stored in the own database. The scheduler processing unit includes a pseudo server processing unit which monitors and receives schedule information broadcasted on the network, and if a final renewal date of the received schedule information is newer than a final renewal date of schedule information stored in the own database, the database is renewed by the received schedule information. That is, the schedule referring processing unit receives only necessary information from information broadcasted on the network. Thus, the database of schedule held by each scheduler is deviated in latest degree of information. When the latest schedule information is to be obtained by the schedule referring processing unit, a scheduler which can open the latest schedule information may not be connected to the network. However, the pseudo server processing unit of the present invention always holds the latest schedule information opened on the scheduler network in the database, and the information is less prone to be deviated. The scheduler processing unit includes a schedule display processing unit for taking in a plurality of schedule information which are required to be adjusted from own database, and for displaying superposing degree of the schedules having different identifiers with color gradation on a screen. Therefore, the superposed schedule with respect to the adjusting other party can easily be found visually, and it is easy to adjust the schedule.

The invention also provides a distributed scheduler system, a distributed scheduler system is constructed by connecting a plurality of schedulers to each other through a network. In this case also, the scheduler includes a database storing schedule information constituted by scheduler identifier for specifying a user, schedule data including contents, starting date and time, ending date and time and the like, and final renewal date; and a scheduler processing unit for processing communication of schedule information at the time of and after subscription into a scheduler group, and withdrawal from the scheduler group by broadcasting. Details of the distributed scheduler system is the same as that of the scheduler.

The present invention provides a schedule adjusting method for adjusting schedules between a plurality of schedulers connected to each other through a network. In the schedule adjusting method of the present invention, a scheduler identifier for identifying a user and schedule information constituted by schedule data are stored in a database of each of scheduler identifiers, and the schedule information is processed by broadcasting with another scheduler. In this schedule adjusting method,

a scheduler connecting request meaning subscription into a scheduler group together with own schedule information are sent to all of the schedulers in the group connected to the network when the scheduler is connected to the network or at given intervals,

schedule information having the scheduler connecting request which is broadcasted on the network is monitored and received, and the received schedule information is added to own database,

a scheduler referring request meaning reference of schedule information of a specific scheduler which is schedule-adjusting other party is sent together with scheduler identifier which is an adjusting other party to all of the schedulers connected to the network, response information from another scheduler is received within a given time from the above sending operation, schedule information of the adjusting other party which has the latest final renewal date is selected to renew the database, and

when scheduler referring request was received from another scheduler, schedule information corresponding to a scheduler identifier of the schedule-adjusting other party is retrieved from own database, the schedule information together with a schedule opening response meaning a response to the scheduler referring request is sent to the network,

schedule information is deleted from the database if it has not been renewed for a given period of time based on the final renewal date of the schedule information stored in the own database.

Further, schedule information broadcasted on the network is monitored and received, and if a final renewal date of the received schedule information is newer than a final renewal date of schedule information stored in the own database, the database is renewed by the received schedule information to construct a pseudo server function. A plurality of schedule information requiring adjustment is taken in from the own database, and superposing degree of schedules having different identifiers is shown with color gradation on a screen.

Further, the present invention provides a computer-readable storing medium in which schedule adjusting program for adjusting schedules between a plurality of schedulers connected to each other through a network is stored. In this storing medium, a scheduler identifier for identifying a user and schedule information constituted by schedule data are stored in a database as the schedule adjusting program, and the schedule information is processed by broadcasting with respect to another scheduler.

### BRIEF DESCRIPTION OF DRAWINGS

FIG. 1 is a block diagram of a distributed scheduler system of the present invention;

FIGS. 2A and 2B are block diagrams of a function construction of the schedule;

FIGS. 3A and 3B are explanatory views of a database and schedule data;

FIGS. 4A to 4D are format explanatory views of communication information of the scheduler;

FIG. 5 is a flowchart of scheduler continuous processing of FIGS. 2A and 2B;

FIG. 6 is a flowchart of scheduler adding processing;

FIGS. 7A and 7B are concrete explanatory views of scheduler connecting processing of FIGS. 2A and 2B;

FIGS. 8A to 8C are concrete explanatory views of the scheduler connecting processing and scheduler adding processing;

FIG. 9 is a flowchart of scheduler referring processing;

FIG. 10 is a flowchart of scheduler opening processing in FIGS. 2A and 2B;

FIGS. 11A and 11B are concrete explanatory views of the scheduler referring processing and the scheduler opening processing;

FIG. 12 is an explanatory view of the database and schedule data before the schedule is referred to;

FIG. 13 is an explanatory view of the database and schedule data after the schedule was referred to;

FIG. 14 is a flowchart of scheduler deleting processing in FIGS. 2A and 2B;

FIGS. 15A and 15B are concrete explanatory views of the database before and after deletion;

FIG. 16 is a flowchart of pseudo server processing in FIGS. 2A and 2B;

FIGS. 17A and 17B are explanatory views of a concrete example of the pseudo server processing;

FIG. 18 is an explanatory view of the database saved by the pseudo server processing in FIGS. 17A and 17B;

FIG. 19 is an explanatory view of a display screen by schedule display processing in FIGS. 2A and 2B; and

FIGS. 20A to 20C are explanatory views of the schedule data used for displaying the schedule in FIG. 19.

### BEST MODE FOR CARRYING OUT THE INVENTION

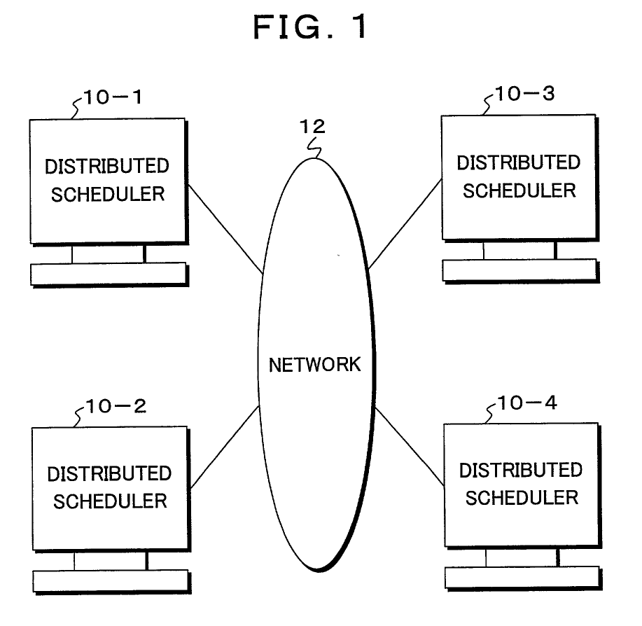

FIG. 1 is a block diagram of system construction of a distributed scheduler system of the present invention. The distributed scheduler system connects a plurality of distributed schedulers 10-1, 10-2, 10-3, 10-4 to network 12. The distributed schedulers 10-1 to 10-4 can be provided by installing an application program of distributed scheduler realizing function of the present invention into an appropriate information terminal apparatus such as a personal computer

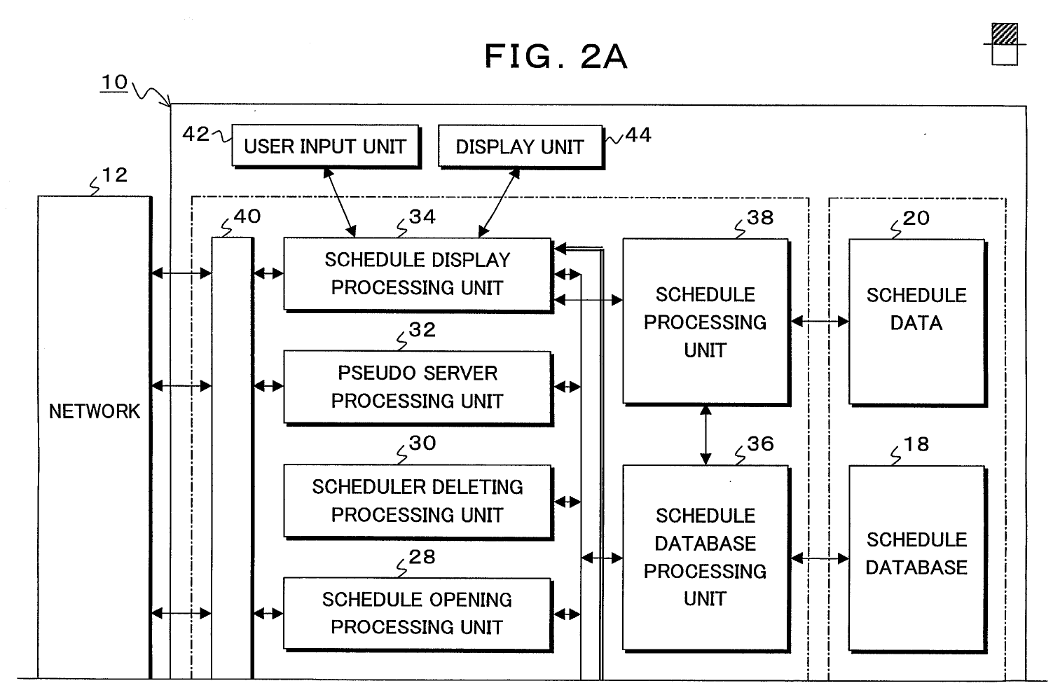

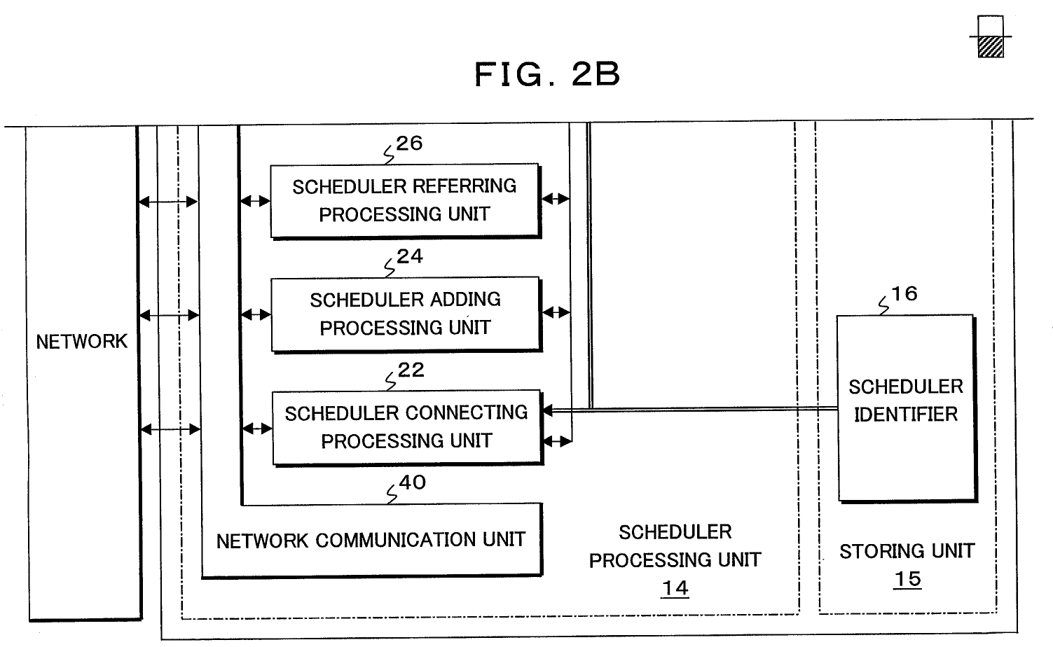

FIGS. 2A and 2B are block diagrams showing apparatus function of a distributed scheduler 10. The distributed scheduler 10 comprises a scheduler processing unit 14, a storing unit 15, a user input unit 40 and a display unit 44. Provided in the scheduler processing unit 14 are a scheduler connecting processing unit 22, a scheduler adding processing unit 24, a schedule referring processing unit 26, a schedule opening processing unit 28, a scheduler deleting processing unit 30, a pseudo server processing unit 32, a schedule display processing unit 34, a schedule database processing unit 36, a schedule processing unit 38 and network communication unit 40. The storing unit 15 is divided into three storage regions, and a scheduler identifier 16, a schedule database 18 and a schedule data 20 are stored in the storing unit 15.

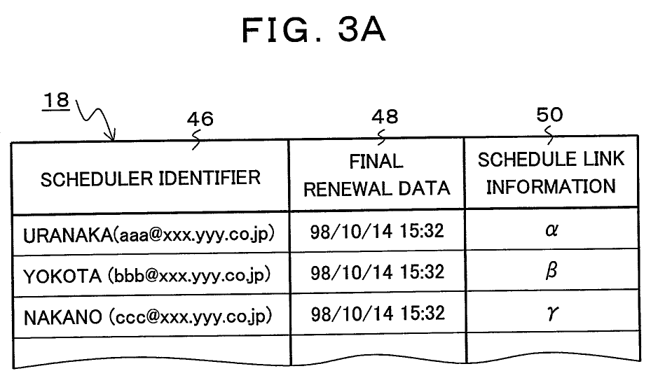

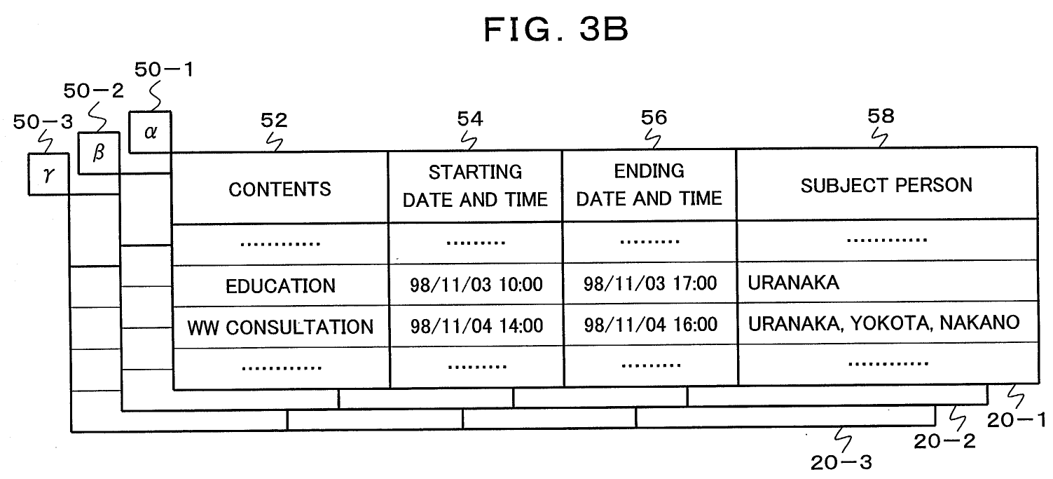

FIGS. 3A and 3B are explanatory views of the schedule database 18 and the schedule data 20 stored in the storing unit 15 in FIGS. 2A and 2B. The schedule database 18 comprises a scheduler identifier 46, a final renewal date 48 and a schedule link information 50. The scheduler identifier 16 is information for uniquely identifying a scheduler user possessed by distributed schedulers 10-1 to 10-4 connected to the network 12 shown in FIG. 1. A mail address of the scheduler user or an account name of the network is utilized as the scheduler identifier 46. FIG. 3A shows a case in which mail addresses of scheduler users “Uranaka”, “Yokota” and “Nakano” are used as the scheduler identifier 46. The mail address of “Uranaka” is “aaa@XXX.yyy.co.jp”. The final renewal date 48 a final date obtained by editing each schedule data 20-1, 20-2, 20-3 shown in FIG. 3B. The form of the final date of “Uranaka” is “98/10/14 15:32” for example. The schedule link information 50 is information for associating the database 18 shown in FIG .3A with schedule data 20-1, 20-2, 20-3 shown in FIG. 3B. For example, if link information shown with “”, “”, “γ” is used, it is possible to be linked with tags 50-1 to 50-3 added to the schedule data 20-1, 20-2, 20-3 shown in FIG. 3B. As shown in the schedule data 20-1 of the scheduler user “Uranaka” as representative, each of the schedule data 20-1,20-2,20-3 in FIG. 3B includes contents 52, starting date and time 54, ending date and time 56 and subject person 58 whose schedule is to be adjusted (schedule-adjustment subject person, hereinafter) 58. That is, the contents 52 are contents of the schedule itself, and “education”, “WW consultation” and the like are stored. The starting date and time 54 are date and time when the schedule is to be started, and is shown as “98/11/03 10:00” for example. The ending date and time 56 are date and time when the schedule is to be ended, and is shown as “98/11/03 17:00” similarly. Further, the subject person 58 is a participant of the schedule, and uses the scheduler identifier 46 of the database 18 shown in FIG. 3(A). In this example, to simplify the explanation, “Uranaka”, “Yokota”, “Nakano” and the like who are scheduler user are stored as the subject persons.

Referring again to FIGS. 2A and 2B, the scheduler processing unit 14 provided in the distributed scheduler 10 adjusts the schedule caused by participation to scheduler group to which the schedulers 10-1 to 10-4 are connected on the network 12 in FIG. 1 or by handling of the schedule information after participation, and deletes a scheduler from the scheduler group by means of broadcast communication while utilizing the scheduler identifier 16, the schedule database 18 and the schedule data 20 stored in the storing unit 15. The processing functions by this scheduler processing unit 14 are:

I. scheduler connecting processing and schedule adding processing for taking into the scheduler group through the network;

II. scheduler referring processing and scheduler opening processing for obtaining latest schedule data by referring to another scheduler for adjusting the schedule;

III. scheduler deleting processing for dropping a scheduler from the scheduler group;

IV. pseudo server processing for always holding another latest schedule information of all schedulers opened in the network; and

V. scheduler display processing for providing a view of a display screen for adjusting the schedule. Among then, the pseudo server function in IV is selectively provided in necessary, and other functions are processing functions commonly provided in all the distributed schedulers. Here, processing procedure of the scheduler 10 when a user of the scheduler 10 in FIGS. 2A and 2B adjusts the schedule is as follows:

I. The scheduler 10 is actuated or is connected to the network 12.

II. The latest schedule data from the scheduler of schedule-adjusting other party is obtained.

III. A schedule of a user to be adjusted is displayed.

IV. The schedule is adjusted and then, the schedule-adjusting other party is requested to confirm the adjustment, and an approval reply is obtained.

V. The schedule data obtained as a result of the adjustment is saved in the person who adjusted the schedule and the schedule-adjusting other party.

To realize such a schedule adjustment, when the scheduler is actuated or is connected to the network, the processing is carried out by the scheduler connecting processing unit 22 and the scheduler adding processing unit 24. In order to obtain the latest schedule data of the schedule-adjusting other party, the schedule referring processing unit 26 and the schedule opening processing unit 28 are actuated. Further, when the schedule is adjusted by displaying the latest schedule data obtained from the schedule-adjusting other party on a display unit 44, the schedule is displayed such that the superposed degree of a plurality of schedules are displayed by way of contrast by the schedule display processing unit 34 for example.

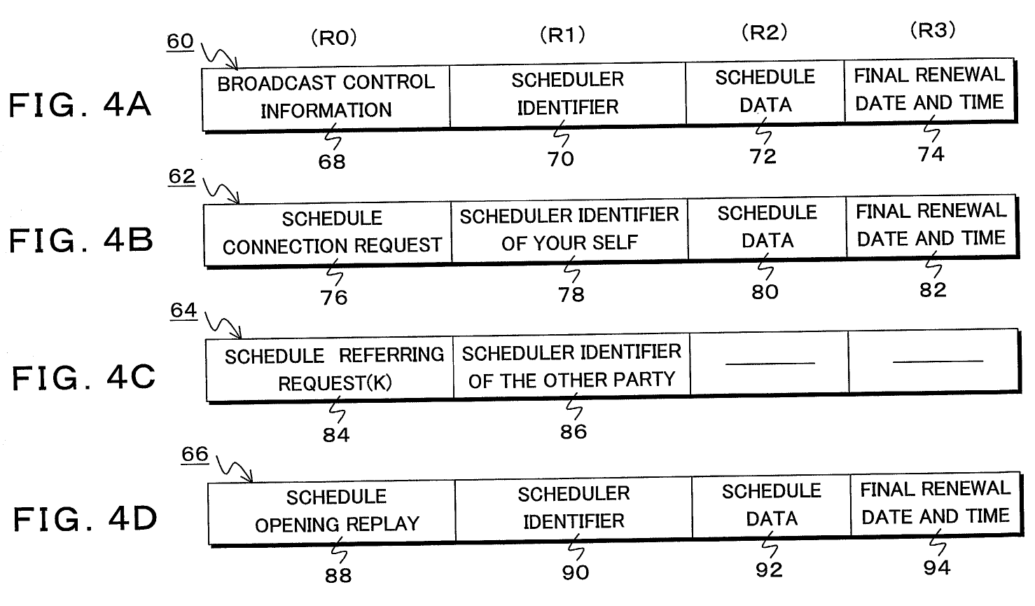

FIGS. 4A and 4D are explanatory views of a information format used in the distributed scheduler system of the present invention carried out between the network 12 and a network communication unit 14 of the scheduler 10 shown in FIGS. 2A and 2B. FIG. 4A shows a basic information format 60 broadcasted on the network for adjusting the schedule, and comprises four records R0, Rl, R2 and R3. The top record R0 is a broadcast control information 68. As shown in FIGS. 4B, 4C and 4D, the record R0 is provided with a schedule connecting request 76, a schedule referring request 84 or a schedule opening response 88. The next record R1 is a scheduler identifier 70. The next record R2 is a schedule data 72 in FIG. 3B. The last record R3 is a final renewal date 74. The basic information format 60 in FIG. 4A is broadcasted as a schedule connecting request information 62 in FIG. 4B, a schedule referring request information 64 in FIG. 4C and a schedule opening response information 66 in FIG. 4D. The schedule connecting request information 62 in FIG. 4B is an information to be broadcasted to all the schedulers connected on the network when connected to the network of the scheduler or at regular intervals. This schedule connecting request information 62 stores a schedule connecting request 76 for all schedulers on the network in the record R0, stores own scheduler identifier 78 in the next record R1, stores a schedule data 80 in the record R2, and provides a final renewal date 82 in the last record R3. The schedule referring request information 64 shown in FIG. 4C provides a schedule referring request 84 in the top record R0, and stores a scheduler identifier 86 of the schedule-adjusting other party requesting to refer in the next record R1. In this case, the record R2 and record R3 are not used. The schedule opening response information 66 in FIG. 4D is a information responding to the schedule referring request information 64, provides the schedule opening response 88 in the record R0, provides a scheduler identifier 90 to be opened in the next record R1, provides a schedule data 92 in the next record R1, and provides a final renewal date 94 in the last record R3.

Processing functions of the scheduler connecting processing unit 22, the scheduler adding processing unit 24, the schedule referring processing unit 26, the schedule opening processing unit 28, the scheduler deleting processing unit 30, the pseudo server processing unit 32 and the schedule display processing unit 34 provided in the scheduler processing unit 14 of the scheduler 10 shown in FIGS. 2A and 2B will be explained in detail.

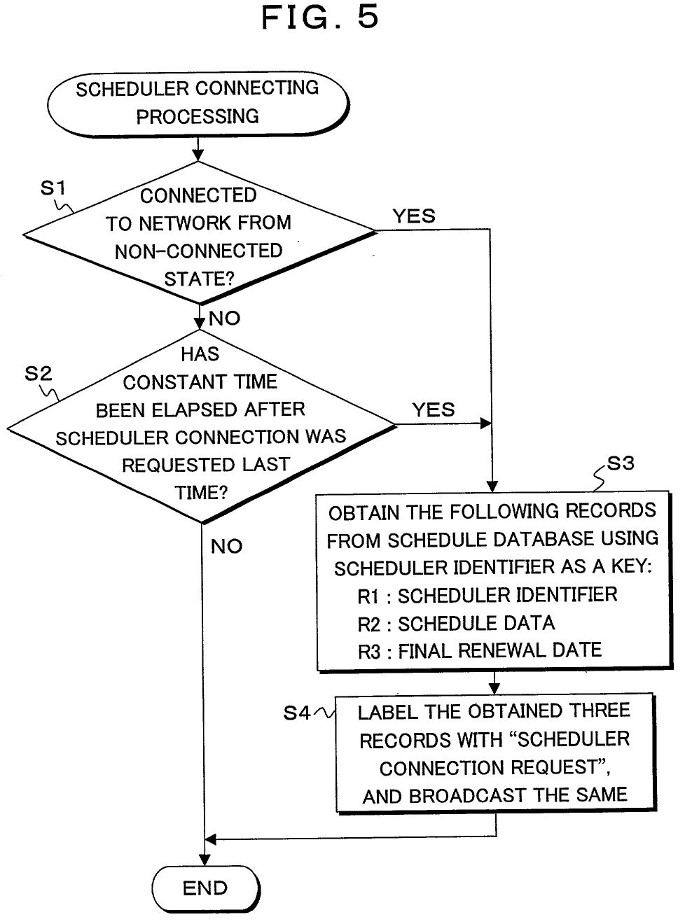

FIG. 5 is a flowchart of the scheduler connecting processing carried by the scheduler connecting processing unit 22 in FIGS. 2A and 2B. When the scheduler is connected to the network, or in a state in which the scheduler is connected to the network, the scheduler connecting processing is carried out whenever a constant time is elapsed in a state. First, in step S1, it is monitored whether a network-connected state is changed to a network-non-connected state. If the state is changed to the network-connected state, the procedure is advanced to step S3. It is checked in step S2 whether the constant time has been elapsed after the scheduler connection was requested last time. If the constant time has been elapsed, the procedure is advanced to step S3 similarly. In step S3, the schedule database 18 and the schedule data 20 are referred to from the scheduler identifier 16 of the storing unit 15 by the schedule database processing unit 36 and the schedule processing unit 38 using the own scheduler identifier as a key, thereby obtaining three records R1, R2 and R3 which are a set of the scheduler identifier, the schedule data and the final renewal date. Then, in a subsequent step S4, the obtained three records R1, R2 and R3 are labeled with “schedule connecting request” as broadcast control information, thereby setting the schedule connecting request information 62 having the format construction shown in FIG. 4B to broadcasting the same.

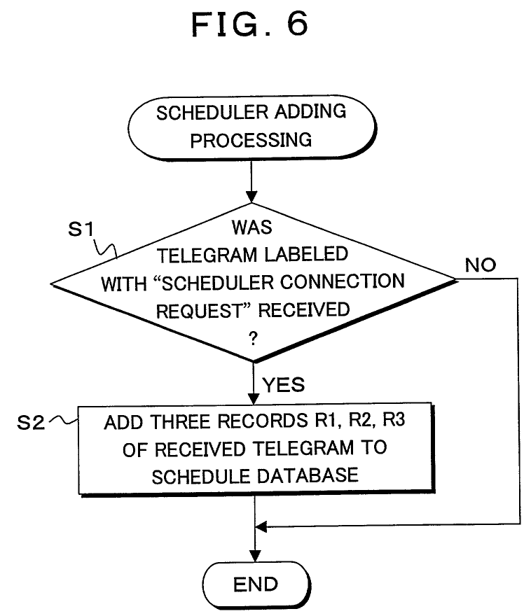

FIG. 6 is a flowchart of the schedule adding processing by the scheduler adding processing unit 24 shown in FIG. 2A and 2B actuated upon reception of the schedule connecting request information 62 sent to the network by the scheduler connecting processing in FIG. 5. In the scheduler adding processing, a information using the “schedule connecting request” as the schedule control information in step S1, and if a information labeled with the “schedule connecting request” is received, the scheduler identifier and schedule data included in the received information and the three records R1, R2 and R3 of the final renewal date are added to the schedule database 18 and the schedule data 20 in step S2.

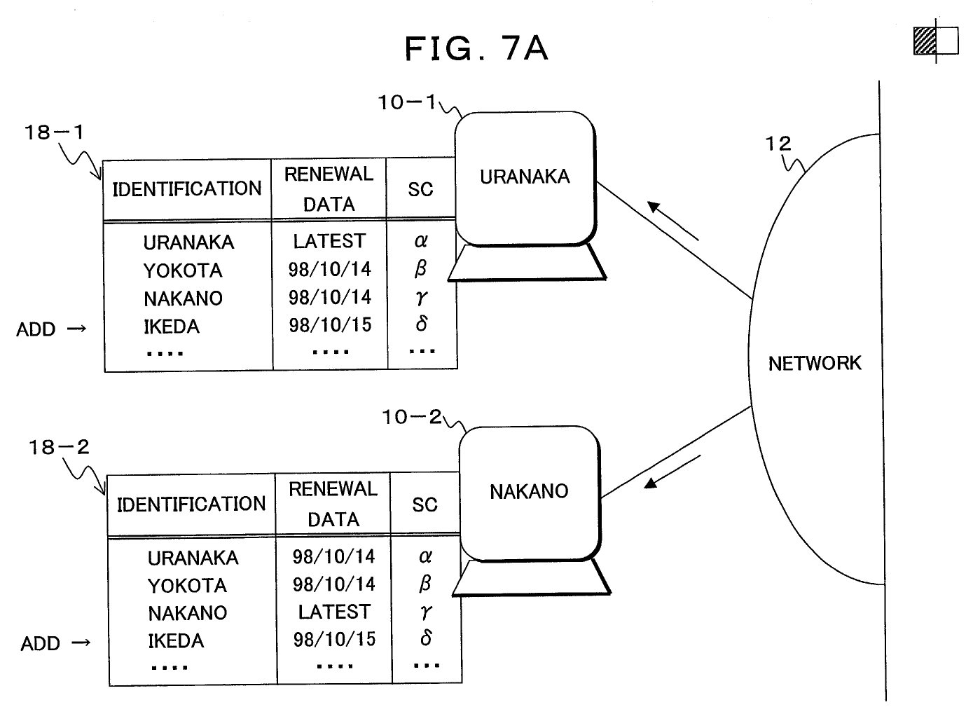

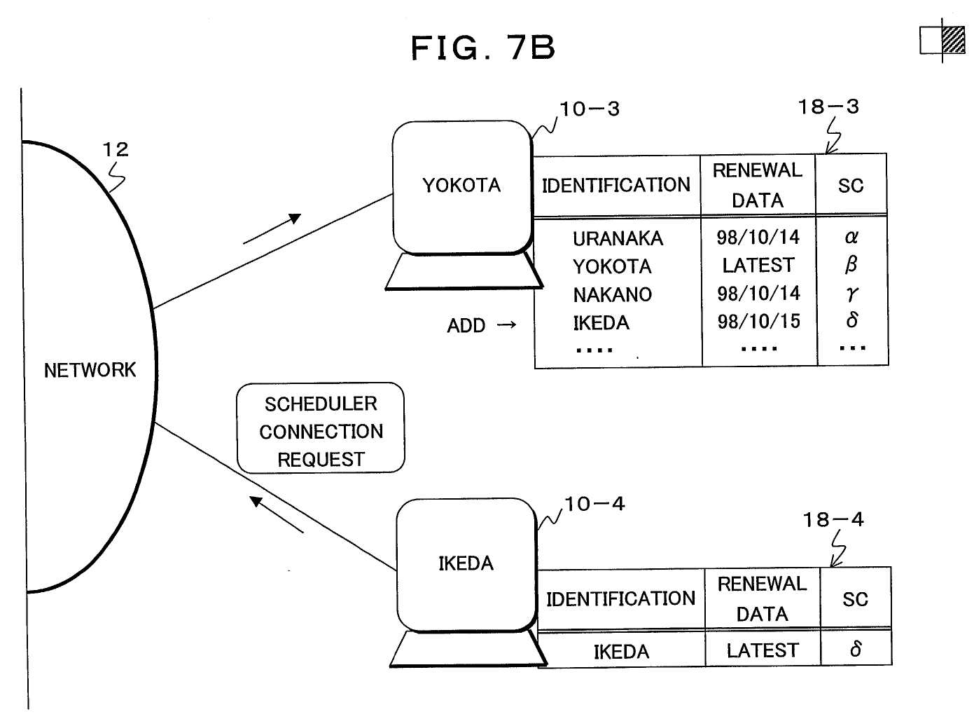

FIGS. 7A and 7B are concrete explanatory views of the scheduler connecting processing and the scheduler adding processing in FIGS. 5 and 6. Four schedulers 10-1 to 10-4 are connected to the network 12, and respectively have “Uranaka”, “Nakano”, “Yokota” and “Ikeda”. In the schedulers 10-1 to 10-4, databases 18-1, 18-2, 18-3 and 18-4 are respectively provided. It is supposed that in a state in which three schedulers 10-1 to 10-3 of the users “Uranaka”, “Nakano” and “Yokota” are connected to the network 12, the scheduler 10-4 of the “Ikeda” is newly connected to the network 12 and requests the scheduler connection. If the schedule connecting request, i.e., the schedule connecting request information 62 having the format shown in FIG. 4B is broadcasted to the network 12 from the scheduler 10-4 of “Ikeda”, the schedule connecting request from the scheduler 10-4 of “Ikeda” is received by the schedulers 10-1 to 10-3 of “Uranaka”, “Nakano” and “Yokota” who already participated. Three records of the scheduler identifier, the schedule data and the final renewal date of “Ikeda” included in the received data are added as “Ikeda, 98/10/15, 6” in the databases 18-1 to 18-3 of “Uranaka”, “Nakano” and “Yokota”. Although it is not illustrated, the schedule data of “Ikeda” added to the received schedule connecting request is added to the schedule data 20 shown in FIGS. 2A and 2B with link relation.

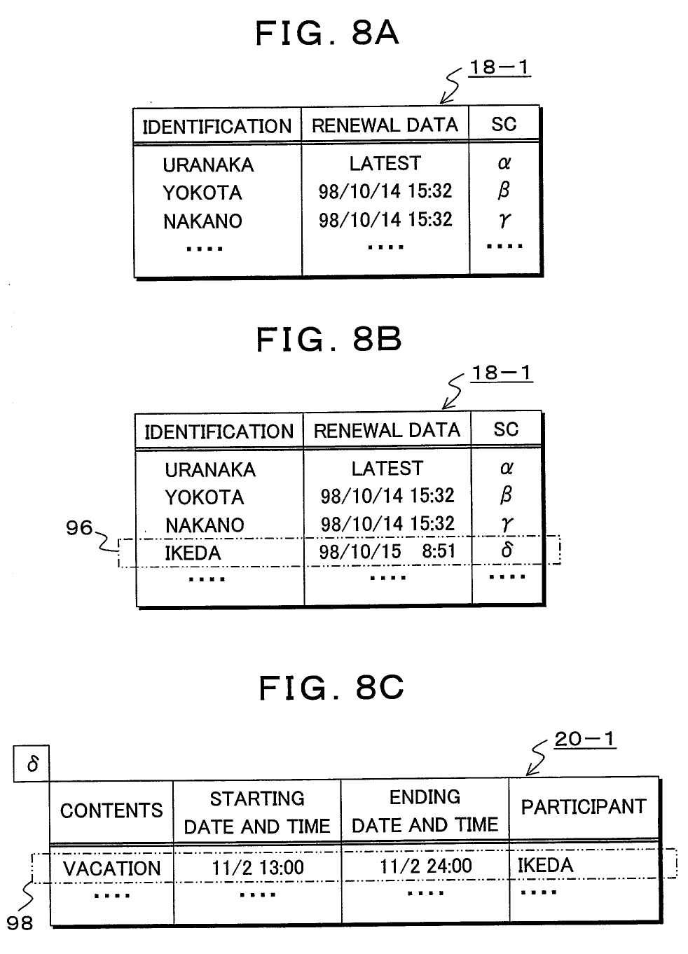

FIG. 8A shows contents before the database 18-1 provided in the scheduler 10-1 of “Uranaka” in FIGS. 7A and 7B is connected, and scheduler information of three users, i.e., “Uranaka”, “Nakano” and “Yokota” who are currently connected to the network are stored. FIG. 8B shows the database 18-1 after the scheduler connection was requested from the scheduler 10-4 of “Ikeda” and the adding processing was carried out. “Ikeda 98/10/15 8:51δ” is added to the database 18-1 as additional data 96. FIG. 8C shows schedule data 20-1 after addition, and schedule data 98 of “Ikeda” who requested the scheduler connection is added.

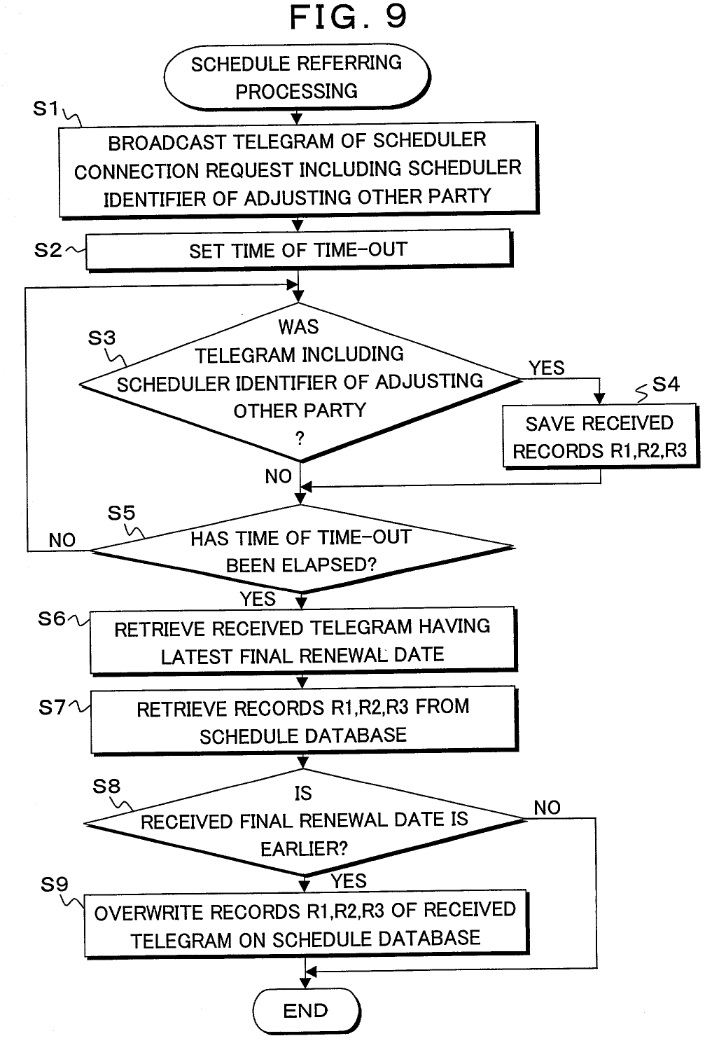

FIG. 9 is a flowchart of the schedule referring processing carried out by the schedule referring processing unit 26 shown in FIGS. 2A and 2B. This scheduler referring processing is a processing function used for obtaining the schedule data of the schedule-adjusting other party as a pretreatment when the schedule is adjusted. That is, when the schedule is adjusted, since the schedule data existing in the database of the own scheduler may not be the latest one, the schedule referring operation is requested to obtain the latest schedule information to the network. In the scheduler referring processing, first in step S1, a information of the schedule connecting request including the scheduler identifier, i.e., the schedule referring request information 64 having the format shown in FIG. 4C is broadcasted to the network. Then, in step S2, a time-out time for aborting the reception of schedule opening information for replying to the referring request is set. Then, in step S3, it is checked whether the information including the scheduler identifier of the schedule-adjusting other party sent in step S1, i.e., more specifically, the schedule opening response information 66 in FIG. 4D was received. If the schedule opening response information 66 was received, the procedure is advanced to step S4 where the records R1, R2 and R3 of the opened scheduler identifier, the schedule data and the final renewal date are once stored in a working region in the storing unit. Then, in a subsequent step S4, it is checked whether the time-out time was elapsed, and the processing in steps S3 and S4 is repeated until the time-out time is elapsed. If the time-out time was elapsed, the procedure is advanced to step S6, the final renewal date corresponding to the record R3 in the three records R1, R2 and R3 stored in step S4 in the work region of the storing unit retrieves the received information. Then, in step S7, the three records R1, R2 and R3 of the scheduler identifier, the schedule data and the final renewal date which are schedule information to be adjusted is retrieved from the database, and is compared in step S8. In the comparison in step S8, it is checked whether the received final renewal date is newer, and if so, the records R1, R2 and R3 of the received information are overwritten on the database in step S9, thereby renewing the latest schedule information.

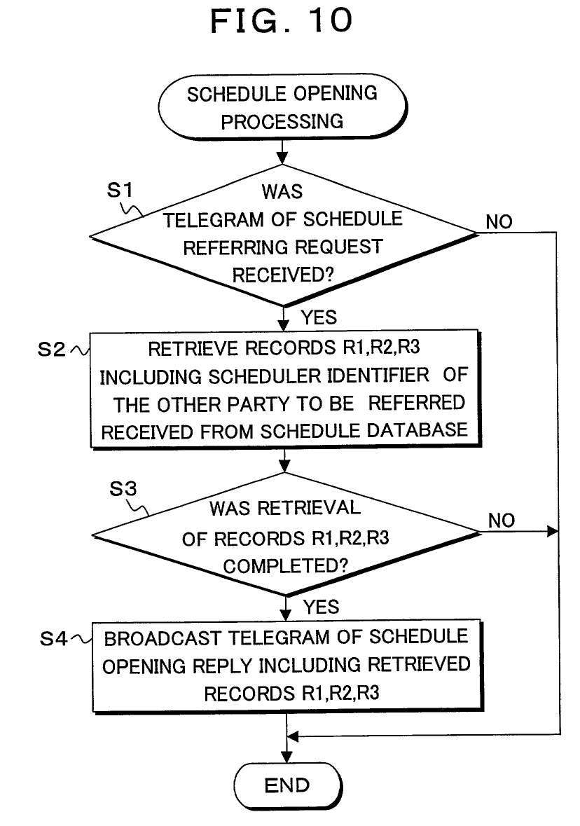

FIG. 10 is a flowchart of the scheduler opening processing carried out by the schedule opening processing unit 28 in FIGS. 2A and 2B. The scheduler opening processing is carried out as reply processing from another scheduler with respect to the schedule referring request sent on the network by the scheduler referring processing shown in FIG. 9. In the scheduler opening processing, it is checked whether an information of the schedule referring request existing on the network was received in step S1. If the information of the schedule referring request was received, the procedure is advanced to step S2 where the schedule information of the records R1, R2 and R3 including the scheduler identifier of the referred schedule-adjusting other party is retrieved. In step S3, if the retrieval operations of the three records R1, R2 and R3 which are the scheduler identifier, the schedule data and the final renewal date have been completed, a schedule opening response information including the retrieved records R1, R2 and R3 is formed as shown in FIG. 4D, and the information is broadcasted to the network. The information sent to the network by the scheduler opening processing in FIG. 10 is received in step S3 of the scheduler referring processing in FIG. 9.

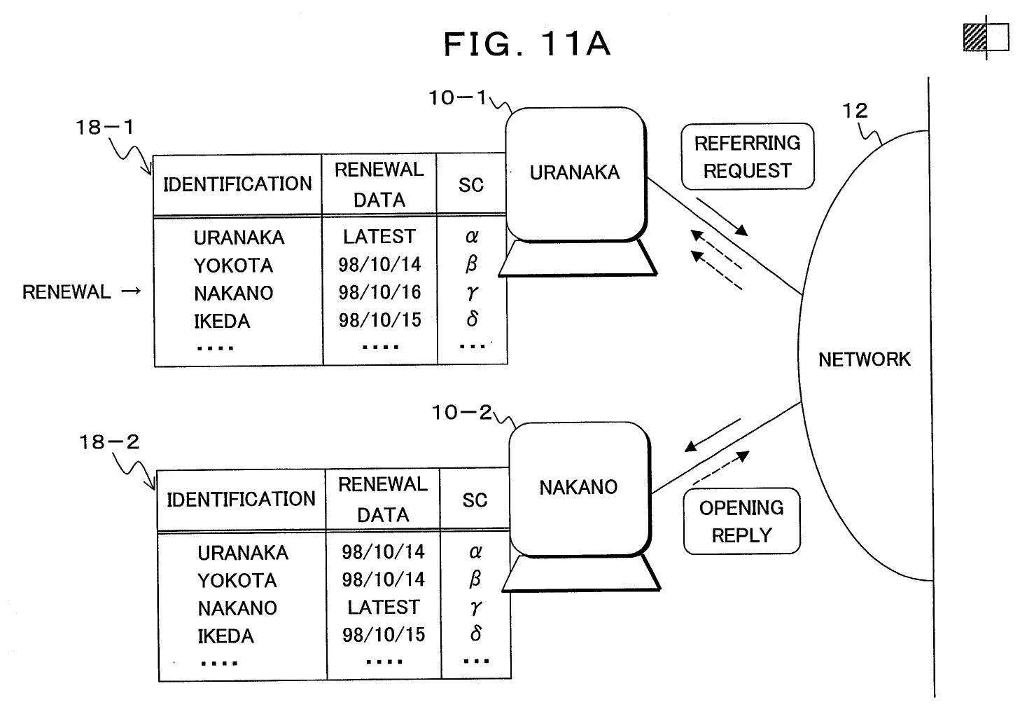

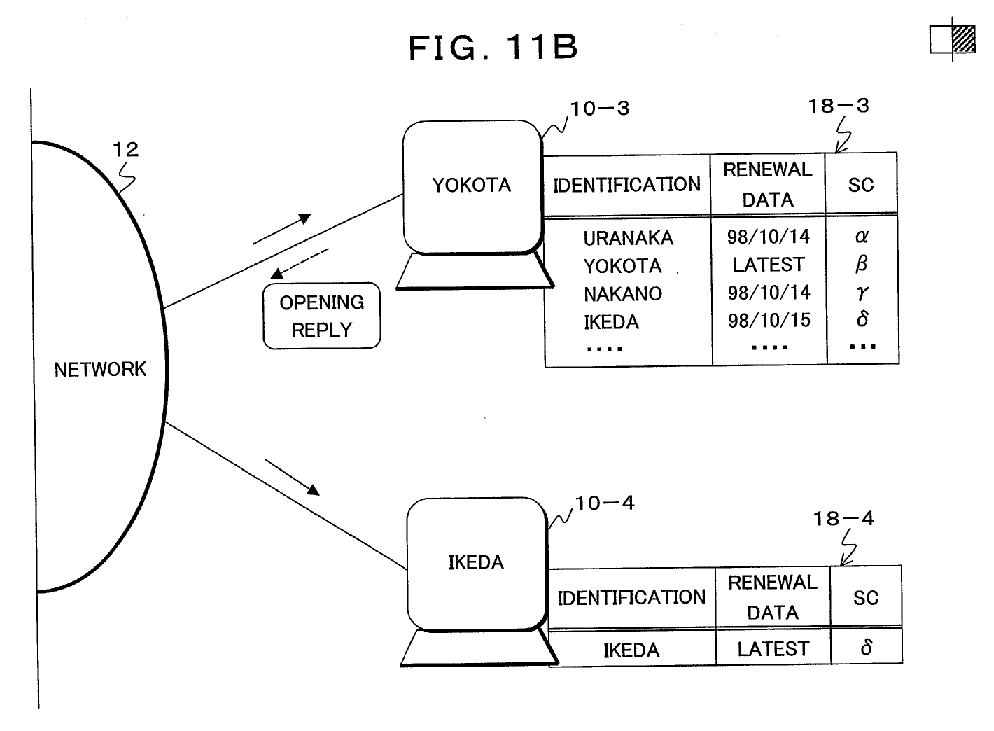

FIGS. 11A and 11B show concrete examples of the scheduler referring processing and the scheduler opening processing in FIGS. 9 and 10. The schedulers 10-1 to 10-4 of the four users, i.e., “Uranaka”, “Nakano”, “Yokota” and “Ikeda” are connected to the network 12. The schedulers 10-1 to 10-4 are respectively provided with the databases 18-1, 18-2, 18-3 and 18-4. The schedule information stored in each of the databases 18-1, 18-2, 18-3 and 18-4 is based on the assumption of “98/10/15 9:18currently”. Now, it is supposed that “Uranaka” carried out the referring processing for obtaining the latest schedule data of “Nakano” and “Ikeda” who are the schedule-adjusting other parties as the pretreatment for adjusting the schedule. With this referring processing, the scheduler 10-1 of “Uranaka” broadcasts the schedule referring request information indicating “Nakano” as the scheduler identifier to the network 12. The schedule referring request information from the scheduler 10-1 of “Nakano” is received by schedulers 10-2 to 10-4 of “Nakano”, “Yokota” and “Ikeda”, and if it is recognized that the information is the schedule referring request, the scheduler identifier “Nakano” is retrieved from the databases 18-2 to 18-4, and the schedule opening response information shown in FIG. 4 having the records R1, R2 and R3 of the scheduler identifier, the final renewal date and the schedule data (not shown) is broadcasted to the network 12. Then, the scheduler 10-1 of “Uranaka” receives the schedule opening response information of scheduler identifier “Nakano” sent from the schedulers 10-2 to 10-4 to the network 12, and holds the schedule opening response information until the time-out time is elapsed. In this case, the schedule 10-4 of “Ikeda” does not have, in the database 18-4, the schedule information of scheduler identifier “Nakano” who requested the referring operation and therefore, the schedule opening response information is not broadcasted to the network 12. Thus, the scheduler 10-1 of “Uranaka” receives and holds the schedule opening response information from the scheduler 10-2 of “Nakano” and the scheduler 10-3 of “Yokota”. Therefore, when the time-out time is elapsed, the final renewal date of the record R3 of the received two information and a renewal date of scheduler identifier “Nakano” of the database 18-1 of the scheduler 10-1 itself are compared, and if there exists the latest final renewal date in the received information, the records R1, R2 and R3 of this information are overwritten on the database 18-1 to renew the database.

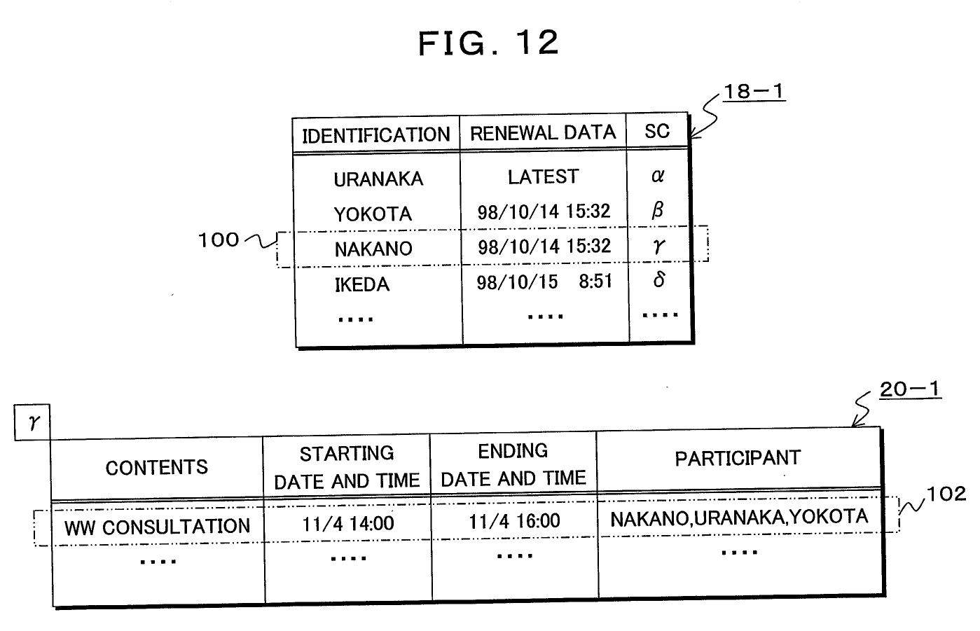

FIG. 12 shows contents of the database 18-1 and the schedule data 20-1 provided in the scheduler 10-1 of “Uranaka” before the referring operation in FIGS. 11A and 11B is requested. Here, the scheduler 10-1 of “Uranaka” selects “Nakano” as the schedule-adjusting other party, and requests the referring operation of the schedule. The final renewal date of the data 100 of the schedule-adjusting other party in this case is “98/10/14 15:32”.

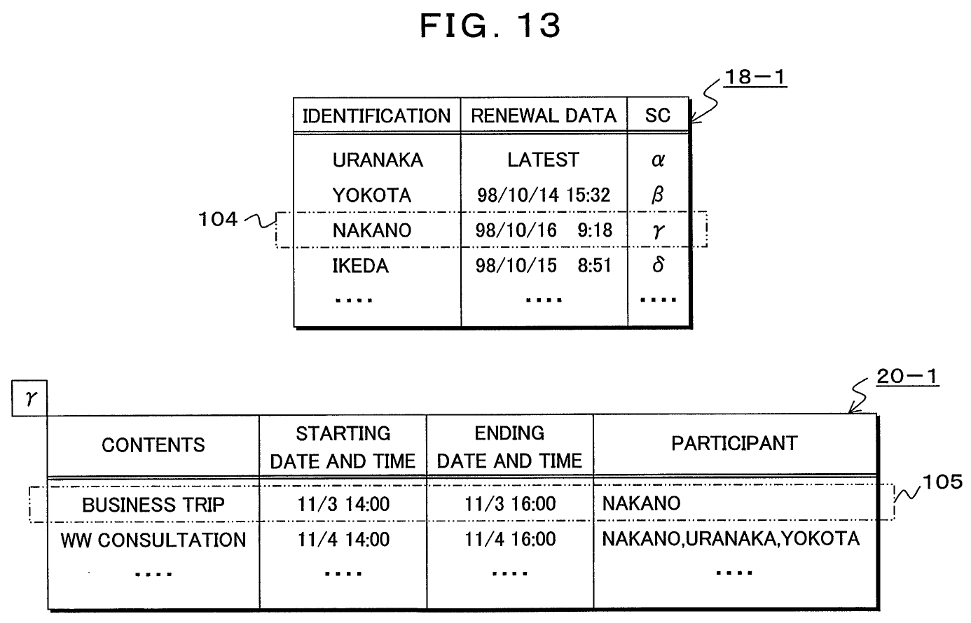

FIG. 13 shows the database 18-1 and the schedule data 20-1 after the opening response was received and renewed after the referring operation in FIGS. 11A and 11B was requested. In this case, since the final renewal date included in the schedule opening response information from the scheduler 10-2 of “Nakano” in FIGS. 11A and 11B is the latest date, the database 18-1 is overwritten by this, and the final renewal date of schedule-adjusting other party “Nakano” is renewed to “98/10/16 9:18” like renewed data 102. With this, the contents of the schedule data 20-1 corresponding to the link information “γ” are renewed to new schedule data 105 from the old schedule data 102 shown in FIG. 12.

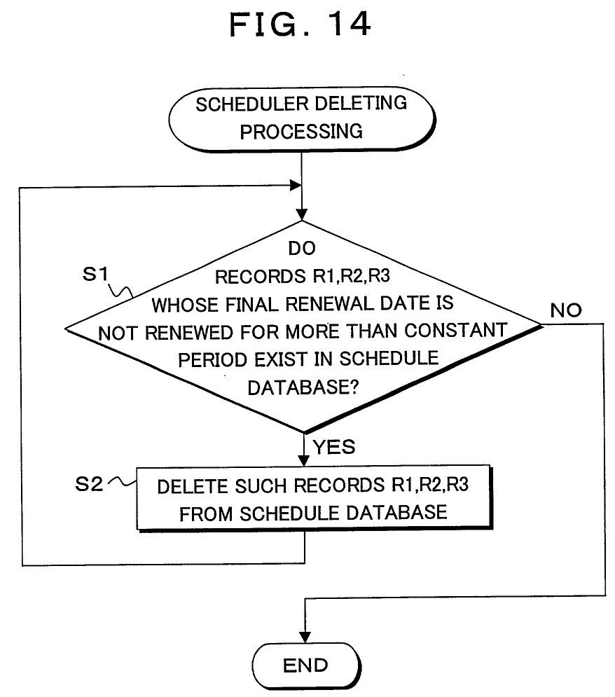

FIG. 14 is a flowchart of the scheduler deleting processing carried out by the scheduler deleting processing unit 30 shown in FIGS. 2A and 2B. In this scheduler deleting processing, it is checked in step S1 whether a set of records R1, R2 and R3 whose renewal date is not renewed for more than a constant period exist. A sufficiently long term period such as one month is set as the constant period of this check. If schedule information which was not renewed for the constant period or longer exists in the database, the procedure is advanced to step S2 where the schedule user corresponding to the schedule information is regarded as a person who is not utilizing the distributed scheduler system any more, and the corresponding records R1, R2 and R3 are deleted from the database in step S2. With this, scheduler user who does not utilize the system for the constant period is automatically withdrawn from the distributed scheduler system. By the scheduler deleting processing for managing the system for the constant period, a user who does not utilize the distributed scheduler system need not carry out special operation such as withdrawing processing and is automatically deleted from the network, and increase in communication load and difficulty of schedule adjustment caused by unnecessary scheduler which need not be adjusted can automatically solved.

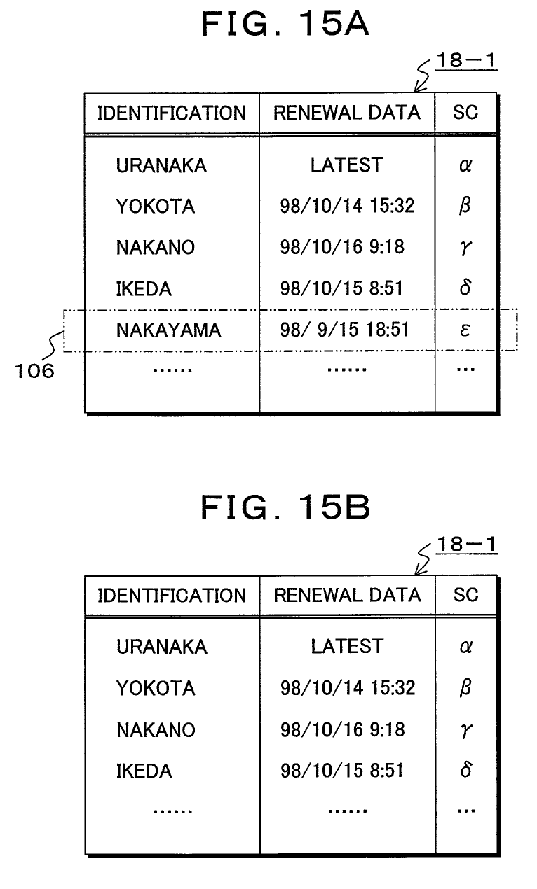

FIG. 15A shows the database 18-1 before the scheduler deleting processing in FIG. 14 is carried out. The numbers of scheduler identifiers are five, i.e., “Uranaka”, “Yokota”, “Nakano”, “Ikeda” and “Nakayama”. FIG. 15B shows the database 18-1 after the scheduler deleting processing was carried out. If the current date is “98/10/15”, the final renewal date of the schedule information of “Nakayama” is “98/9/15” which is one month old. Therefore, since this satisfies the condition of the predetermined time lapse for of the deleting processing, this is automatically deleted from the database 18-1.

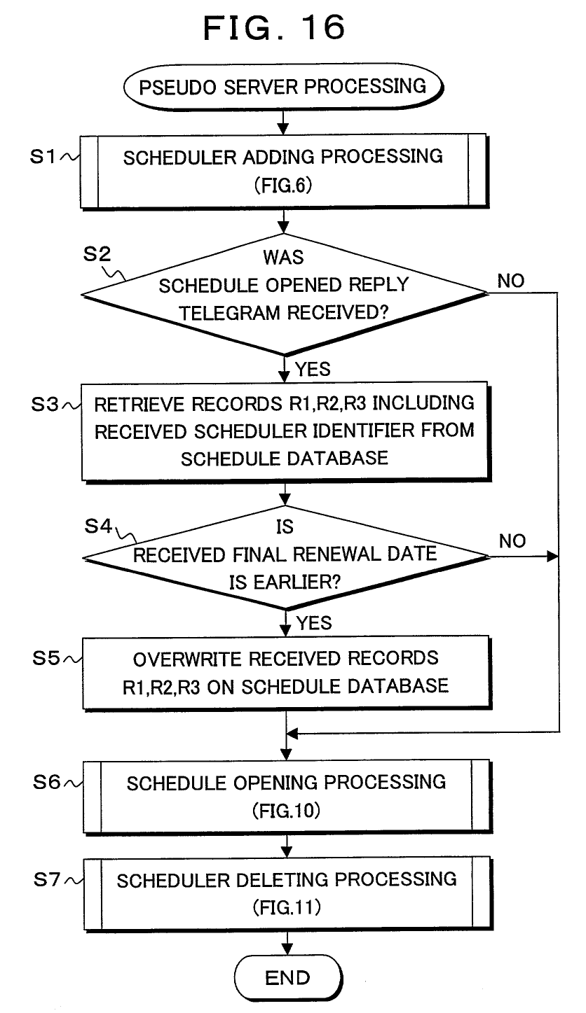

FIG. 16 is a flowchart of a pseudo server processing carried out by the pseudo server processing unit 32 in FIGS. 2A and 2B. Of the scheduler information broadcasted on the network by the scheduler connecting processing, the schedule adding processing, the scheduler referring processing, the scheduler opening processing and the scheduler deleting processing, only the schedule information that the scheduler himself desires to obtain is received. Therefore, in this scheduler, the latest properties of the database of the schedule information held by each scheduler is biased. For example, when the latest schedule information of the schedule-adjusting other party is to be obtained by the scheduler referring processing, a scheduler who can open the latest schedule information to be referred to may not be connected to the network and the latest schedule information necessary for adjusting the schedule may not be obtained in some cases. Thereupon, a particular scheduler among the plurality of schedulers connected to the network is provided a function as a pseudo server processing unit. The scheduler having the pseudo server processing unit always holds the latest schedule information for each scheduler opened on the network. Thus, when one scheduler requested the referring operation for adjusting the schedule, even if a scheduler of the schedule-adjusting other party is not connected to the network, the latest schedule information of the schedule-adjusting other party can be opened from the scheduler having the pseudo server processing unit. Therefore, even if the schedule-adjusting other party is not connected to the network, the latest schedule information can reliably be obtained.

In the pseudo server processing in FIG. 16, first, the scheduler adding processing is carried out in step S1. This scheduler adding processing is the same as the scheduler adding processing shown in the flowchart of FIG. 6. Schedule information of a scheduler who was newly subscribed into the scheduler group is added to the database with respect to the schedule connecting request of FIG. 5 caused by the scheduler connecting processing. In a subsequent step S2, it is checked whether the schedule opening response information was received. If the schedule opening response information was received from the network, the records R1, R2 and R3 including the received scheduler identifier are retrieved from the database of the schedule in step S3, and the retrieved records are compared with the final renewal date in step S4. If the received final renewal date is newer, the received records R1, R2 and R3 are overwritten on the schedule database to renew the latest schedule information in step S5. By the processing in steps S2 to S5, all the schedule opening response information existing on the network are obtained by the scheduler having the pseudo server processing unit, and if it is newer than the final renewal date of the schedule information that is already saved, the database is overwritten to renew the database. The scheduler opening processing in next step S6 is the same as that shown in the flowchart of the scheduler opening processing in FIG. 10, and carries out the opening and responding operation based on reception of the schedule referring request information on the network that was broadcasted by the scheduler referring processing in FIG. 9. The scheduler deleting processing in next step S7 is the same as that shown in the flowchart in FIG. 14. If there are records R1, R2 and R3 having final renewal date that was not renewed for a constant period or longer, these records R1, R2 and R3 are deleted from the database.

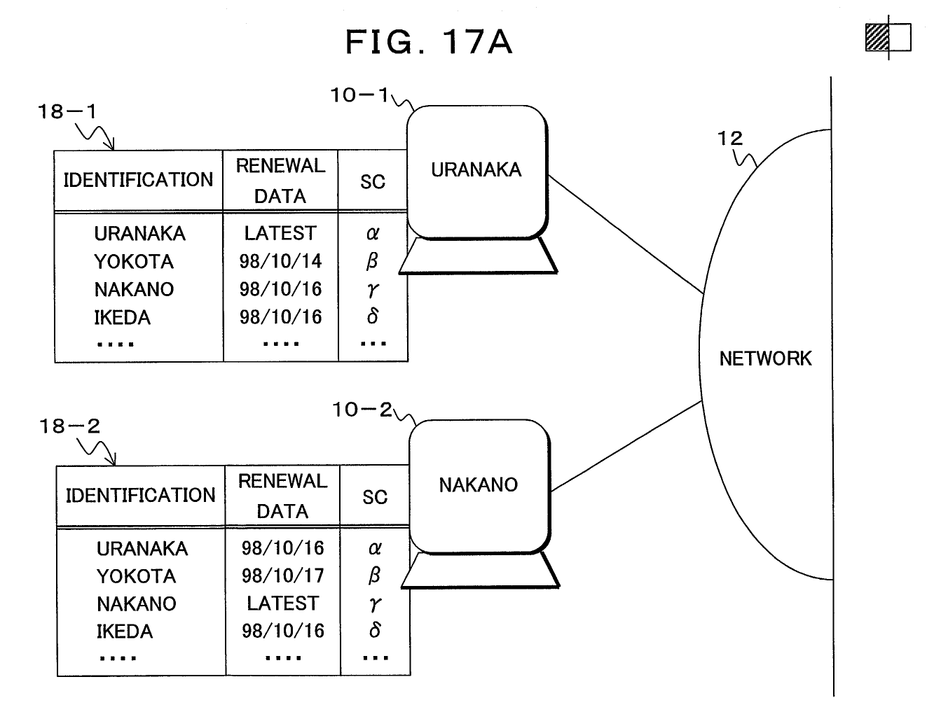

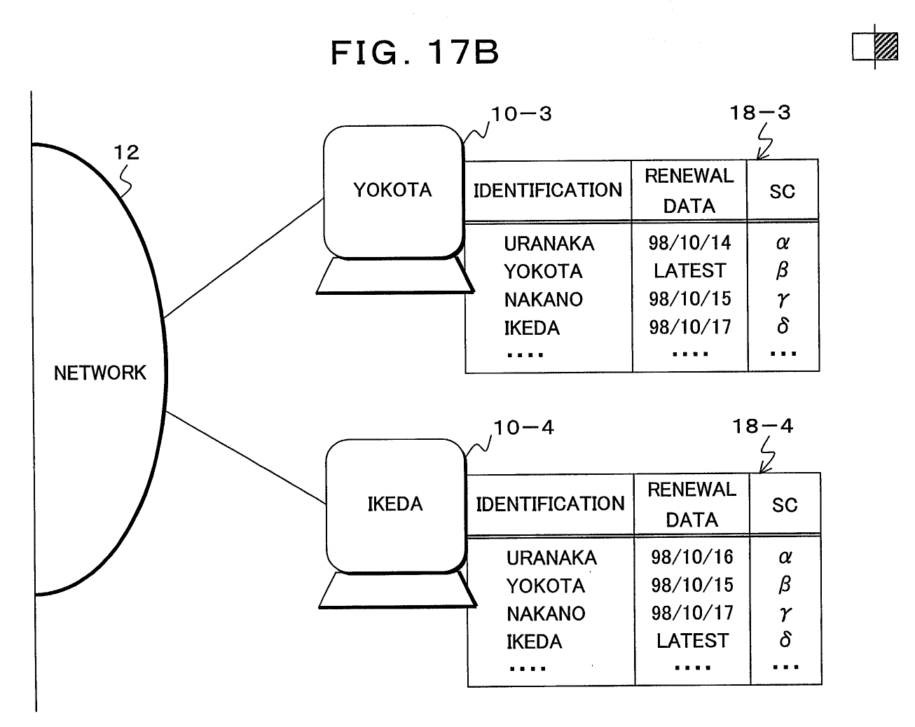

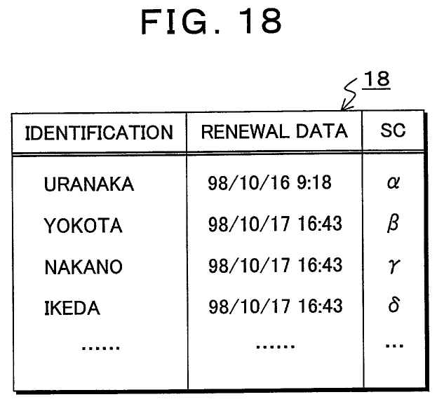

FIGS. 17A and 17B show concrete examples of a system state when the pseudo server processing is carried out, and four schedulers 10-1 to 10-4 of “Uranaka”, “Nakano”, “Yokota” and “Ikeda” are connected to the network 12. In such as state, if the function of the scheduler processing shown in FIG. 16 is allowed to be exhibited in any one of the schedulers 10-1 to 10-4, a database 18 shown in FIG. 18 for example is generated. The database 18 has “Uranaka”, “Yokota”, “Nakano” and “Ikeda” as scheduler identifiers, and its final renewal date is the latest renewal date of each the scheduler identifier in FIGS. 17A and 17B. For example, the renewal date of the top “Uranaka” is “98/10/16 9:18”, and it can be found that the databases 18-1 and 18-4 of the schedulers 10-1 and 10-4 of “Uranaka” and “Ikeda” in FIGS. 17A and 17B have the latest information. The database 18 by the pseudo server processing unit shown in FIG. 18 is realized by a particular scheduler among the schedulers 10-1 to 10-4 in FIGS. 17A and 17B. Therefore, when the referring operation was requested for adjusting the schedule, even if a scheduler of the schedule-adjusting other party did not exist on the network, the schedule opening response information is broadcasted from a scheduler having the latest schedule information in the database 18 as shown in FIG. 18, and the latest schedule information can stably be obtained.

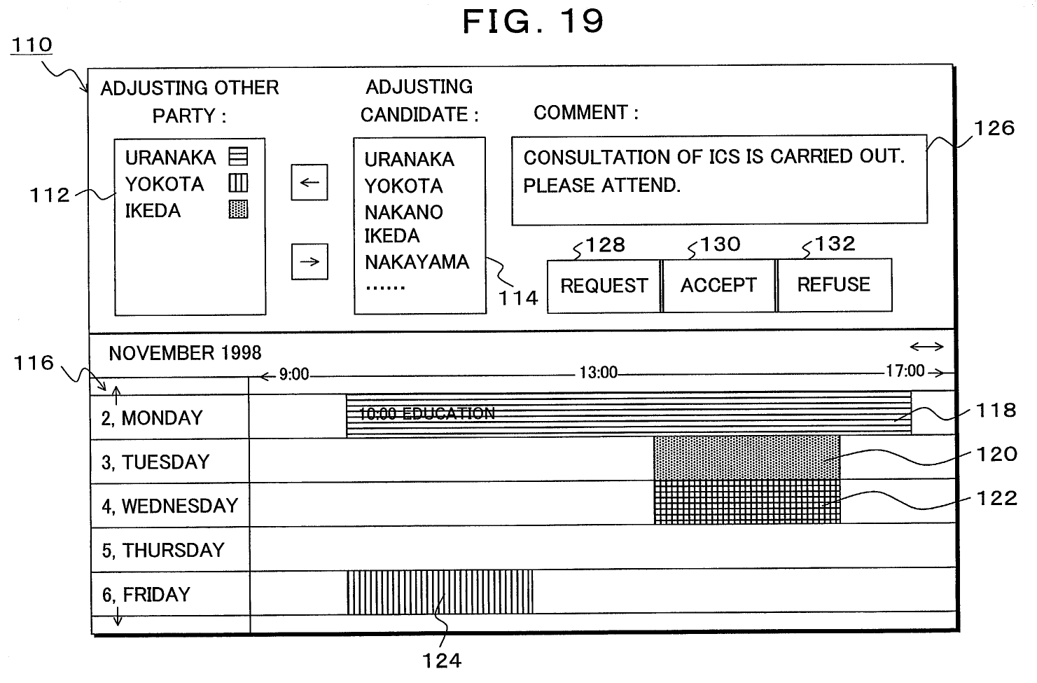

FIG. 19 is an explanatory view of an adjusting screen of a schedule displayed on the display unit 44 when the schedule is adjusted by the schedule display processing unit 34 shown in FIGS. 2A and 2B. The schedule adjusting screen 110 displays an adjusting candidate list 112 and an adjusting other party list 114 on the right side of the unit on the screen. In the adjusting candidate list 112, all scheduler identifiers stored in the scheduler identifier 16 of the storing unit in FIGS. 2A and 2B are displayed by the retrieval of the own database when the scheduler adding processing is actuated. In this case, the “Uranaka”, “Yokota”, “Nakano”, “Ikeda” and “Nakayama” are displayed as adjusting candidates. If user sees the adjusting candidate list 112 and selects the schedule-adjusting other party, the selected schedule-adjusting other party is displayed in the adjusting other party list 114. In this case, three persons, i.e., “Uranaka”, “Yokota” and “Ikeda” are selected as schedule-adjusting other parties in the adjusting other party list 114. If the schedule-adjusting other party is selected in the adjusting other party list 114, the scheduler of the present invention automatically requests the schedule referring operation to the schedule-adjusting other party to obtain the latest schedule information. If the latest schedule information of the schedule-adjusting other party is obtained, a schedule of “Uranaka” who adjusts the schedule and schedules of “Yokota” and “Ikeda” who are the schedule-adjusting other parties are displayed in the schedule table 116 located at a lower portion of the schedule adjusting screen 110 in a form of a bar graph.

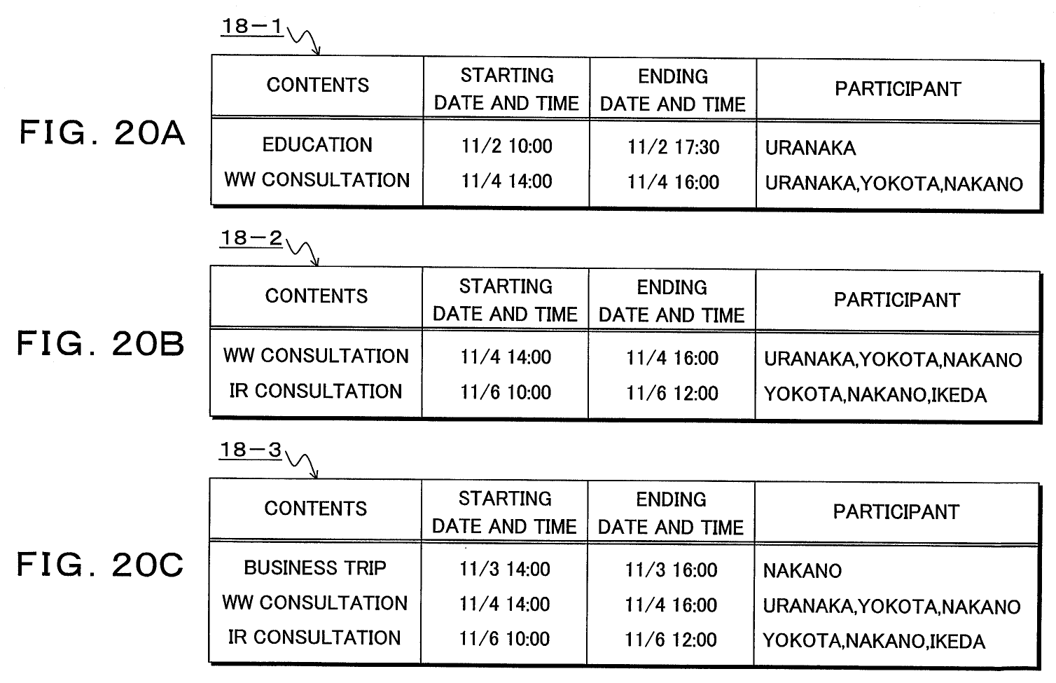

FIGS. 20A to 20C show the database 18-1 of “Uranaka” who adjusts the schedule selected in the schedule-adjusting other party list, the database 18-2 of “Yokota” who is the schedule-adjusting other party and the database 18-3 of “Ikeda” who is another schedule-adjusting other party. In the schedule table 116, colors, e.g., R, G and B allocated to “Uranaka”, “Yokota” and “Ikeda” based on the database shown in FIGS. 20A to 20C as shown in the adjusting other party list 114. Therefore, a schedule bar 118 is displayed as a single schedule of “Uranaka” in the schedule table 116. A schedule bar 124 is displayed as a single schedule of “Yokota” . Further, a schedule bar 120 is displayed as a single schedule of “Ikeda”. Whereas, in “Nov. 4, 1998” schedule 122 of schedule table 116, schedules of three persons, i.e., “Uranaka”, “Yokota” and “Ikeda” are superposed. Therefore, the superposed schedules of the single schedule bars 118, 120 and 124 are displayed in dark colors with respect to the schedule bar 122 on which the three persons' schedules are superposed. Thus, in the case of “Uranaka” who adjusted the schedule using the schedule adjusting screen 110, it can be found that three persons' schedules are adjusted by the schedule bar 122 only by seeing the schedule table 116. If the schedule was again adjusted by seeing the schedule table 116, a schedule which was input to be adjusted again is broadcasted to “Yokota” and “Ikeda” who are the schedule-adjusting other parties. More concretely, if the schedule was adjusted on the schedule adjusting screen, a a message such as “ICS consultation will be conducted. Please attend the consultation.” is input to a comment 126 on the right side on the screen, a request button 128 is clicked by a mouse, and a schedule request in which the input schedule information is broadcasted to “Yokota” and “Ikeda” is carried out. In the schedule-adjusting other parties “Yokota” and “Ikeda” who received such a schedule request, the contents of the requested schedule are displayed on the schedule adjusting screen, and if there is no problem in the adjustment result, the acceptance button 130 is clicked, and the adjustment result is not acceptable, a rejection button 132 is clicked. If the acceptance button 130 was clicked, agreement information is broadcast to “Uranaka” who is the schedule-adjusting person. If the agreement of the schedule adjustment could be obtained from the schedule-adjusting other, the schedule information that is a result of adjustment is stored in database of each of the schedulers of both the schedule-adjusting person and schedule-adjusting other party.

As embodiments of the computer-readable storing medium in which a program for executing the schedule adjusting processing is stored according to the present invention, there are a removable portable storing medium such as a CD-ROM, a floppy disk, a storing device of a program provider who provides a program by line, and a memory device such as a RAM and a hard disk of a processing device in which a program is installed. The program supplied from the storing medium is loaded into the processing device, and executed on the main memory.

The present invention is not limited to the above embodiments, and the invention includes appropriate modifications which does impair the object and merit of the invention. The present invention is not limited by numerical values taught in the embodiments.

Industrial Applicability

As explained above, according to the present invention, the distributed scheduler system is constructed only by connecting a plurality of schedulers to each other through a network, and no server is necessary for unitarily managing the schedule information and thus, it is easy to introduce the schedulers at initial state only if a client functioning as the scheduler exists.

Further, since the server does not unitarily manage the schedulers of users, it is easy to increase or decrease the scheduler users with respect to the network by subscription or automatic deletion, subscription or withdrawal into or from the distributed scheduler system can be done only by disposing a client or discarding the client without doing special operation such as informing to that effect to the scheduler manager.

Furthermore, when the schedule is adjusted, since superposing portion between a schedule-adjusting other party and a schedule is shown with color gradation on the schedule adjusting screen, it is possible to recognize the time superposition at a glance, and to adjust a schedule efficiently.

1. Schedulers for constructing a scheduler system by connecting the schedulers through a network, wherein each of said schedulers comprising
a database in which a scheduler identifier for identifying a user and schedule information constituted by schedule data are stored, and
a scheduler processing unit for processing the schedule information by broadcasting with respect to another scheduler.

2. The schedulers according to claim 1, wherein said scheduler processing unit includes a scheduler connecting processing unit which sends a scheduler connecting request meaning subscription into a scheduler group together with own schedule information to all of the schedulers in the group connected to the network when the scheduler is connected to the network or at given intervals.

3. The schedulers according to claim 2, wherein said scheduler processing unit monitors schedule information having the scheduler connecting request which is broadcasted on the network, and adds received schedule information to own database.

4. The schedulers according to claim 1, wherein said schedule information includes final renewal date, said scheduler processing unit sends a scheduler referring request meaning reference of schedule information of a specific scheduler which is schedule-adjusting other party together with scheduler identifier which is an adjusting other party to all of the schedulers connected to the network, receives response information from another scheduler within a given time from the above sending operation, and selects schedule information of the adjusting other party which has the latest final renewal date to renew the database.

5. The schedulers according to claim 4, wherein
said scheduler processing unit has a scheduler opening processing unit which retrieves schedule information corresponding to a scheduler identifier of the schedule-adjusting other party from own database when said scheduler processing unit received scheduler referring request from another scheduler, wherein said scheduler opening processing unit sends the schedule information together with a schedule opening response meaning a response to said scheduler referring request to the network.

6. The schedulers according to claim 1, wherein
said schedule information includes a final renewal date, said scheduler processing unit includes a scheduler deleting processing unit which deletes schedule information from the database if it has not been renewed for a given period of time based on the final renewal date of the schedule information stored in the own database.

7. The schedulers according to claim 1, wherein
said schedule information includes final renewal date, said scheduler processing unit includes a pseudo server processing unit which monitors and receives schedule information broadcasted on the network, and if a final renewal date of the received schedule information is newer than a final renewal date of schedule information stored in the own database, the database is renewed by the received schedule information.

8. The schedulers according to claim 1, wherein
said scheduler processing unit includes schedule display processing unit for taking in a plurality of schedule information which are required to be adjusted from own database, and for displaying superposing degree of the schedules having different identifiers with color gradation on a screen.

9. A schedule adjusting method for adjusting schedules between a plurality of schedulers connected to each other through a network, wherein
a scheduler identifier for identifying a user and schedule information constituted by schedule data are stored in a database of each of scheduler identifiers,
and the schedule information is processed by broadcasting with another scheduler.

10. The method according to claim 9, wherein
a scheduler connecting request meaning subscription into a scheduler group together with own schedule information are sent to all of the schedulers in the group connected to the network when the scheduler is connected to the network or at given intervals,
schedule information having the scheduler connecting request which is broadcasted on the network is monitored and received, and the received schedule information is added to own database,
a scheduler referring request meaning reference of schedule information of a specific scheduler which is schedule-adjusting other party is sent together with scheduler identifier which is an adjusting other party to all of the schedulers connected to the network, response information from another scheduler is received within a given time from the above sending operation, schedule information of the adjusting other party which has the latest final renewal date is selected to renew the database,
and when scheduler referring request was received from another scheduler, schedule information corresponding to a scheduler identifier of the schedule-adjusting other party is retrieved from own database, the schedule information together with a schedule opening response meaning a response to said scheduler referring request is sent to the network,
schedule information is deleted from the database if it has not been renewed for a given period of time based on the final renewal date of the schedule information stored in the own database.

11. A computer-readable storing medium in which schedule adjusting program for adjusting schedules between a plurality of schedulers connected to each other through a network is stored, wherein
a scheduler identifier for identifying a user and schedule information constituted by schedule data are stored in a database as the schedule adjusting program, and the schedule information is processed by broadcasting with respect to another scheduler.

12. The storing medium according to claim 11, wherein
a scheduler connecting request meaning subscription into a scheduler group together with own schedule information are sent to all of the schedulers in the group connected to the network when the scheduler is connected to the network or at given intervals, schedule information having the scheduler connecting request which is broadcasted on the network is monitored and received, and the received schedule information is added to own database,
a scheduler referring request meaning reference of schedule information of a specific scheduler which is schedule-adjusting other party is sent together with scheduler identifier which is an adjusting other party to all of the schedulers connected to the network, response information from another scheduler is received within a given time from the above sending operation, schedule information of the adjusting other party which has the latest final renewal date is selected to renew the database,
and when scheduler referring request was received from another scheduler, schedule information corresponding to a scheduler identifier of the schedule-adjusting other party is retrieved from own database, the schedule information together with a schedule opening response meaning a response to said scheduler referring request is sent to the network,
schedule information is deleted from the database if it has not been renewed for a given period of time based on the final renewal date of the schedule information stored in the own database.

13. A distributed scheduler system, wherein
a scheduler group is formed by connecting a plurality of schedulers to each other through a network,
each of said schedulers comprises
a database in which a scheduler identifier for identifying a user and schedule information constituted by schedule data are stored, and
a scheduler processing unit for processing the schedule information by broadcasting with respect to another scheduler.
